(19) United States
(12) Patent Application Publication
(10) Pub. No.: US 2013/0291742 A1
(43) Pub. Date: Nov. 7, 2013

(54) SCREEN PRINTER AND SCREEN PRINTING METHOD

(71) Applicants: Seikou Abe, Osaka (JP); Toshiyuki Murakami, Yamanashi (JP)

(72) Inventors: Seikou Abe, Osaka (JP); Toshiyuki Murakami, Yamanashi (JP)

(73) Assignee: PANASONIC CORPORATION, Osaka (JP)

(21) Appl. No.: 13/979,316

(22) PCT Filed: Feb. 16, 2012
(86) PCT No.: PCT/JP2012/001038

§ 371 Date: Jul. 11, 2013

(30) Foreign Application Priority Data
Feb. 21, 2011 (JP) 2011-034089

(51) Int. Cl. B41M 1/12

(52) U.S. Cl. CPC B41M 1/12
USPC 101/123

(57) ABSTRACT

Provided are a screen printer and a screen printing method capable of reducing poor printing by realizing smooth rolling of a paste. When a squeegee 32 is slid on a mask 5 so as to transfer a paste Ps to a substrate 2, leakage prevention members 33 are slid on the mask 5 along with the squeegee 32 so as to prevent the paste Ps on the mask 5 from leaking out of both sides of the squeegee 32. The height H0 of the paste Ps on the mask 5 is greater than the height Hm of the leakage prevention members 33 from the upper surface of the mask 5, and the paste Ps located at a position greater than the height Hm of the leakage prevention members 33 is rolled.

### TECHNICAL FIELD

The present invention relates to a screen printer and a screen printing method in which a squeegee is slid on a mask which comes into contact with an upper surface of a substrate, a paste supplied onto the mask is rolled on the mask by the squeegee, and thereby the paste is transferred to the substrate so as to be printed.

### BACKGROUND ART

A screen printer is an apparatus which transfers a paste such as a solder paste or a conductive paste to each of a plurality of electrodes provided on a substrate so as to be printed, in which a mask having openings which are formed according to electrode disposition of the substrate comes into contact with an upper surface of the substrate such that the openings and the electrodes conform to each other, a paste is supplied onto the mask, and a spatula-shaped squeegee is slid on the mask. Thereby, the paste is rotated (rolled) between the mask and the squeegee and is moved on the mask so as to fill the openings of the mask and to be transferred to the electrodes on the substrate, and, then, when a plate separation is performed by separating the mask from the substrate, the paste remains on the electrodes, which leads to a state in which the paste is printed on the electrodes.

Among these screen printers, a screen printer is known in which a pair of leakage prevention members provided in a squeegee holder holding a squeegee is slid on a mask along with the squeegee such that a paste rolled on the mask efficiently fills openings of the mask, and thereby the paste rolled on the mask is prevented from leaking out of both sides of the squeegee from the center of the squeegee in a width direction (for example, PTL 1).

### CITATION LIST

### Patent Literature

[PTL 1] JP-A-2004-34638

### SUMMARY OF INVENTION

### Technical Problem

However, in the above-described screen printer in the related art, there is a problem in that, since rolling of the paste is performed in a state in which the maximum height of the paste does not exceed the height of the leakage prevention member such that the paste is rolled in a state in which the paste is placed in a partition formed by the squeegee and the leakage prevention member, frictional resistance from the leakage prevention member acts on both ends of the paste of which rolling is in progress (this paste of which rolling is in progress may be regarded as having a columnar shape which extends in a longitudinal direction of the squeegee as a whole), and this impedes smooth rolling of the entire paste and causes a poor printing state.

Therefore, an object of the present invention is to provide a screen printer and a screen printing method capable of realizing smooth rolling of a paste so as to reduce the occurrence of poor printing.

### Solution to Problem

A screen printer of the invention includes a mask that comes into contact with an upper surface of a substrate; a squeegee that is slid on the mask which comes into contact with the upper surface of the substrate and rolls a paste supplied onto the mask on the mask so as to transfer the paste to the substrate; and a leakage prevention member that is provided in a squeegee holder holding the squeegee and is slid on the mask along with the squeegee so as to prevent the paste of which rolling is in progress on the mask from leaking out of both sides of the squeegee from a center of the squeegee in a width direction, in which the paste is rolled in a state in which a height of the paste on the mask is greater than a height of the leakage prevention member from the upper surface of the mask, and the paste located at a position greater than the height of the leakage prevention member does not exceed the leakage prevention member and thus does not flow out of both sides of the squeegee from the center of the squeegee in the width direction.

A screen printing method of the invention includes a process of causing a mask to come into contact with an upper surface of a substrate; a process of causing a squeegee to be slid on the mask which comes into contact with the upper surface of the substrate and to roll a paste supplied onto the mask on the mask so as to transfer the paste to the substrate; and a process of causing a leakage prevention member provided in a squeegee holder holding the squeegee to be slid on the mask along with the squeegee so as to prevent the paste of which rolling is in progress on the mask from leaking out of both sides of the squeegee from a center of the squeegee in a width direction, in which the paste is rolled in a state in which a height of the paste on the mask is greater than a height of the leakage prevention member from the upper surface of the mask, and the paste located at a position greater than the height of the leakage prevention member does not exceed the leakage prevention member and thus does not flow out of both sides of the squeegee from the center of the squeegee in the width direction.

### Advantageous Effects of Invention

In the present invention, a paste is rolled in a state in which the height of the paste on a mask is greater than the height of leakage prevention members from an upper surface of the mask, and the paste located at a position greater than the height of the leakage prevention members does not exceed the leakage prevention members and thus does not flow out of both sides of the squeegee from the center of the squeegee in the width direction. Therefore, it is possible to reduce frictional resistance from the leakage prevention members acting on both ends of the paste of which rolling is in progress while the leakage prevention members prevent leakage of the paste out of the squeegee. Thereby, it is possible to realize smooth rolling of the entire paste and to reduce occurrence of poor printing.

### <BRIEF DESCRIPTION OF DRAWINGS>

FIG. 1 is a schematic configuration diagram of a screen printer according to an embodiment of the present invention.

FIG. 2 is a side view of the screen printer according to the embodiment of the present invention.

FIG. 3 is a front view of the screen printer according to the embodiment of the present invention.

FIG. 4 is a plan view of the screen printer according to the embodiment of the present invention.

FIG. 5 is view in which (a) and 5(b) are respectively a perspective view and an exploded perspective view of a squeegee unit included in the screen printer according to the embodiment of the present invention.

FIG. 6 is a partially enlarged view of the squeegee unit included in the screen printer according to the embodiment of the present invention.

FIG. 7 is view in which (a) and 7(b) are respectively a partial side view and a partial front view of the squeegee unit included in the screen printer according to the embodiment of the present invention.

FIG. 8 is a flowchart illustrating execution procedures of a screen printing method performed by the screen printer according to the embodiment of the present invention.

### DESCRIPTION OF EMBODIMENTS

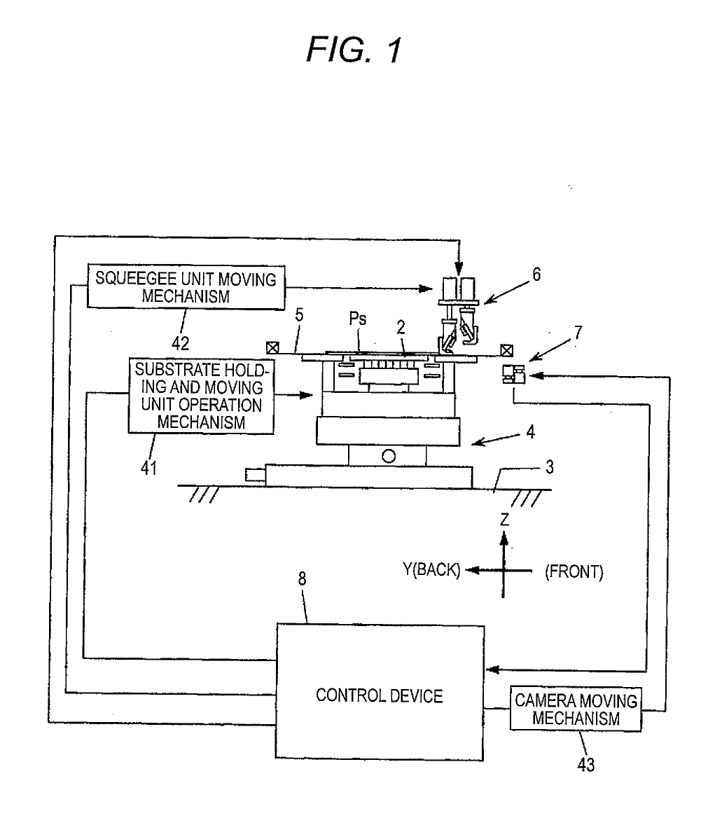

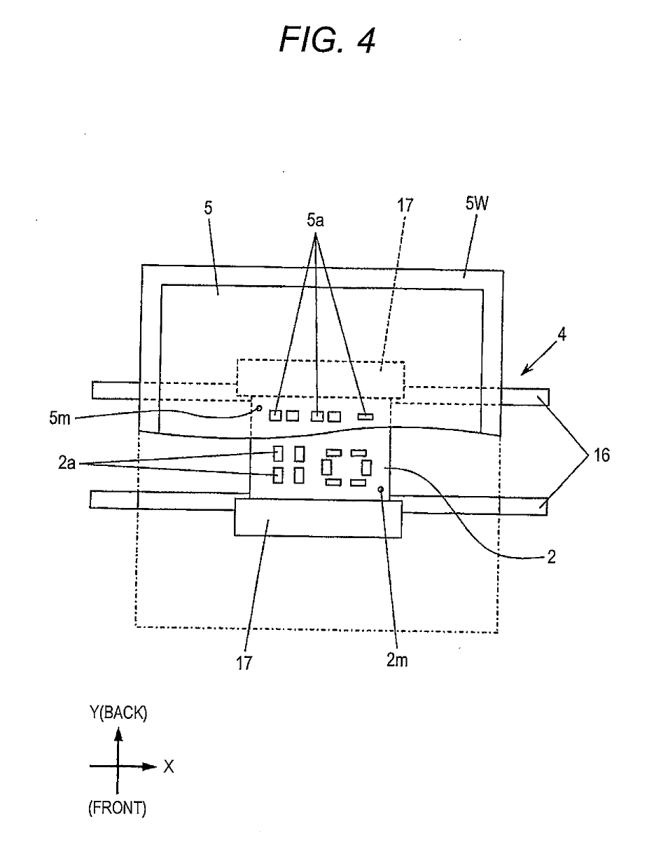

Hereinafter, embodiments of the present invention will be described with reference to the drawings. A screen printer 1 shown in FIGS. 1, 2 and 3 is an apparatus which repeatedly performs a series of processes including an operation of carrying in a substrate 2, an operation of printing a paste Ps such as a solder paste or a conductive paste on each of a plurality of electrodes 2a (FIG. 4) provided on the carried-in substrate 2, and an operation of carrying out the substrate 2 on which the paste Ps is printed.

In FIGS. 1, 2 and 3, the screen printer 1 includes a substrate holding and moving unit 4 which is provided on a base 3 and functions as a substrate holding portion transporting, positioning and holding the substrate 2 and a substrate moving portion moving the held substrate 2; a mask 5 which makes openings 5a (FIG. 4) conform to electrodes 2a on the substrate 2 held by the substrate holding and moving unit 4 and comes into contact with an upper surface of the substrate 2; a squeegeeing mechanism 6 which is slid on the mask 5 coming into contact with the upper surface of the substrate 2, and sweeps a paste Ps supplied onto the mask 5 on the mask 5 so as to be rolled (rotated), thereby transferring the paste Ps to the electrodes 2a on the substrate 2 via the openings 5a of the mask 5; a camera unit 7 which performs an imaging operation; and a control device 8 which performs operation control on the respective portions.

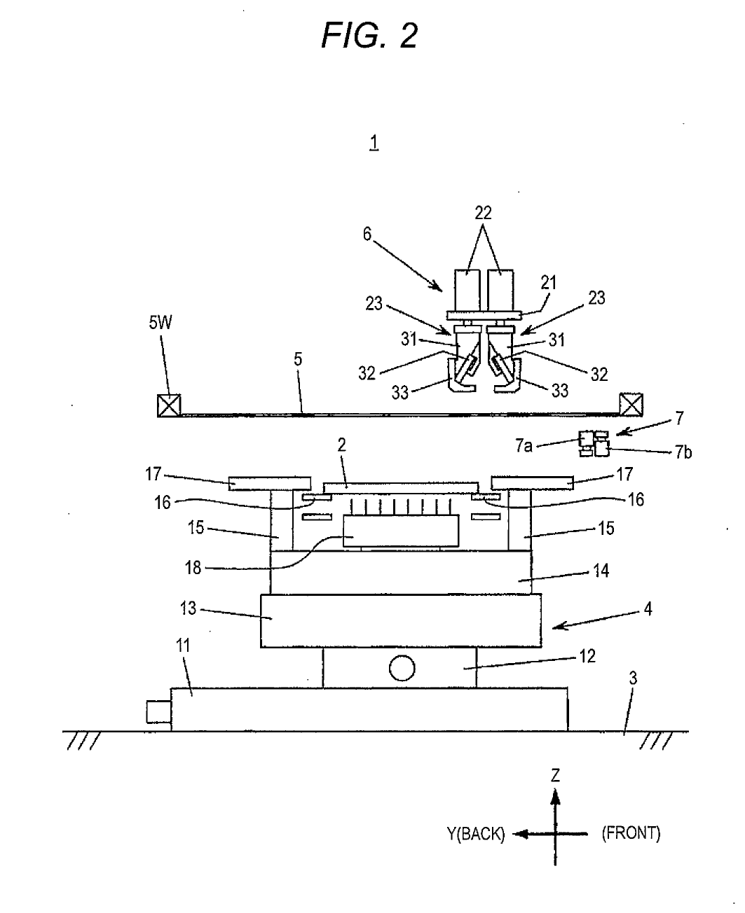

Hereinafter, for convenience of description, an in-horizontal surface direction in which the substrate 2 is transported in the screen printer 1 is set to an X axis direction, an in-horizontal surface direction perpendicular to the X axis direction is set to a Y axis direction, and a vertical direction is set to a Z axis. In addition, the Y axis direction is set to a front-back direction of the screen printer 1, the X axis direction is set to a transverse (horizontal) direction of the screen printer 1, and, in the front-back direction, a side (the right side of FIGS. 1 and 2) in which an operator (not shown) performs work on the screen printer 1 is set to a front side of the screen printer 1, and an opposite side (the left side of FIGS. 1 and 2) thereto is set to a back side.

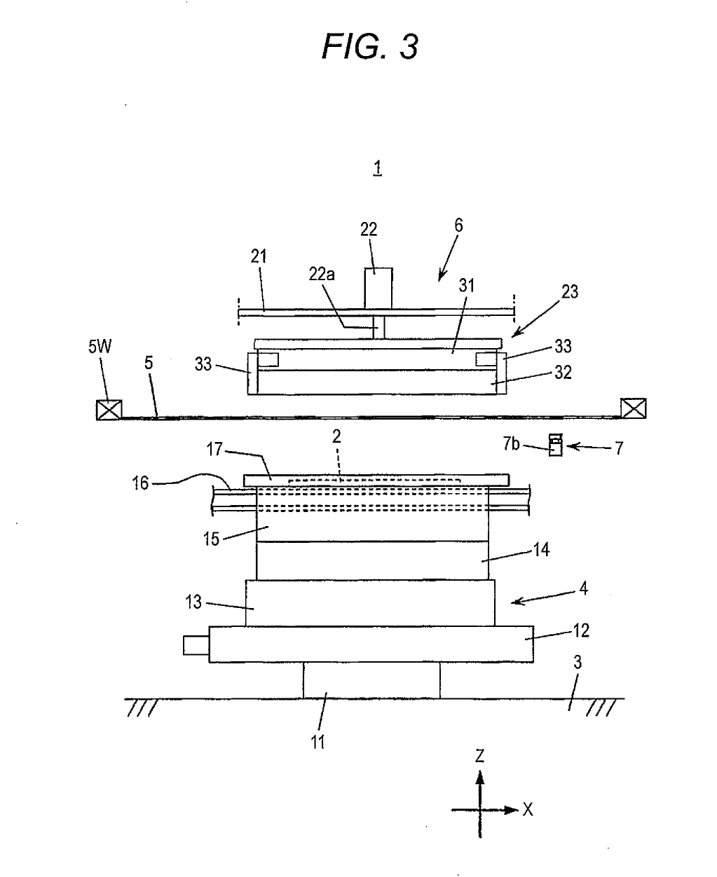

In FIGS. 2 and 3, the substrate holding and moving unit 4 includes a base portion 14 which can move in a horizontal surface with respect to the base 3 through relative movements of a Y table 11, an X table 12, and a θ table 13 stacked on the base 3, and can move up and down with respect to the base 3 through a vertical movement relative to the θ table 13. A pair of struts 15 which are provided so as to be opposite to each other in the Y axis direction on an upper surface of the base portion 14 are provided with a pair of transport conveyers 16 extending in the X axis direction, and a pair of clamping members 17 (refer to FIG. 4) which are freely opened and closed in the Y axis direction. In addition, a lower receiving member 18 which freely moves up and down with respect to the base portion 14 is provided at the center of the base portion 14.

In FIGS. 2, 3 and 4, the pair of transport conveyers 16 support both ends in the Y axis direction of the substrate 2 from the lower side, and transport the substrate in the X axis direction so as to be positioned. A pair of clamping members 17 are opened and closed in the Y axis direction, and clamp both ends in the Y axis direction of the substrate 2 which is positioned by the transport conveyers 16. The lower receiving member 18 moves up and down with respect to the base portion 14, and supports (lower-receives) the central part of the substrate 2 clamped by the clamping members 17 from the lower side.

In FIG. 4, four sides of the mask 5 are supported by a mask frame 5W which is formed of a rectangular frame-shaped member in plan view, and the openings 5a are provided in a rectangular region surrounded by the mask frame 5W.

In FIG. 4, a set of two substrate side marks 2m is provided at the diagonal position of the substrate 2 (in FIG. 4, only one substrate side mark 2m is shown), and a set of two mask side marks 5m which is disposed so as to correspond to the substrate side marks 2m is provided in the mask 5 (in FIG. 4, only one mask side mark 5m is shown). When the substrate 2 comes into contact with the mask 5 in a state in which the substrate side marks 2m conform to the mask side marks 5m in plan view, the electrodes 2a of the substrate 2 coincide with the openings 5a of the mask 5.

In FIGS. 2 and 3, the squeegeeing mechanism 6 includes a squeegee base 21 which is provided so as to freely move in the Y axis direction, a pair of squeegee lifting cylinders 22 which are installed on an upper surface side of the squeegee base 21, and a pair of squeegee units 23 which move up and down independently from each other on the lower side of the squeegee base 21 by the pair of squeegee lifting cylinders 22.

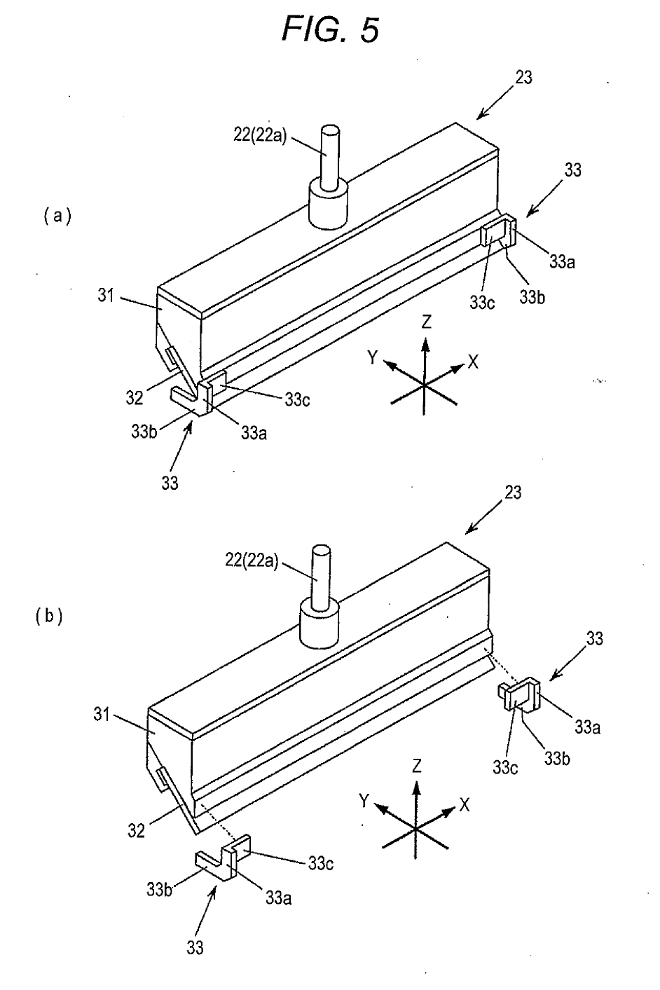

In FIGS. 2, and 3, and (a) and (b) in FIG. 5, each of the squeegee units 23 includes a squeegee holder 31 which is installed at a lower end of a rod 22a of the squeegee lifting cylinder 22 and extends in the X axis direction, a spatula-shaped squeegee 32 which is formed of a plate-shaped member extending in the X axis direction and of which an upper part is held by the squeegee holder 31 and a lower part obliquely extends toward a lower side of the squeegee holder 31, and a pair of leakage prevention members 33 provided in the squeegee holder 31. Here, the pair of leakage prevention members 33 are provided at positions where the squeegee 32 is interposed between both ends thereof in a longitudinal direction (X axis direction) in the present embodiment.

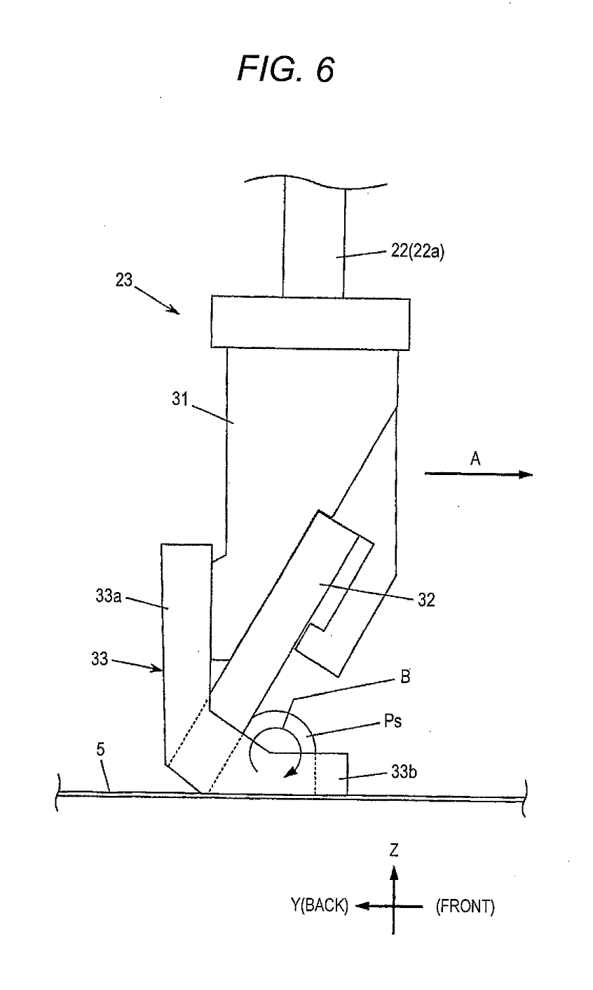

Each of the leakage prevention members 33, as shown in (a) and (b) in FIG. 5 and FIG. 6, includes a vertical portion 33a which extends in the Z axis direction (vertical direction) and a horizontal portion 33b which extends in the Y axis direction (horizontal direction) from the lower end of the vertical portion 33a, so as to be formed in an L shape as a whole, and an installation portion 33c for installing the leakage prevention member 33 on the back surface (the surface on the opposite side to the side facing the two squeegee units 23) of the squeegee holder 31 is provided so as to extend from the upper end of the vertical portion 33a in the X axis direction.

In FIGS. 2 and 3, the camera unit 7 includes a first camera 7a of which an imaging view field is directed downward and a second camera 7b of which an imaging view field is directed upward.

A movement operation in the horizontal surface and a vertical movement operation of the base portion 14 included in the substrate holding and moving unit 4 are performed by the control device 8 performing operation control on a substrate holding and moving unit operation mechanism 41 (FIG. 1) constituted by an actuator (not shown) and the like, such that relative movement operations in the in-horizontal surface direction of the Y table 11, the X table 12 and the θ table 13 are performed and a rotation operation of Z axis rotation of the base portion 14 with respect to the θ table 13 is performed. In addition, transport and positioning operations of the substrate 2 by the transport conveyers 16, a clamping operation of the positioned substrate 2 by the clamping members 17, and a lower receiving operation of the substrate 2 by the lower receiving member 18 are also performed by the control device 8 performing operation control on the substrate holding and moving unit operation mechanism 41.

A movement in the Y axis direction of the squeegee base 21 included in the squeegeeing mechanism 6 is performed by the control device 8 performing operation control on a squeegee unit moving mechanism 42 (FIG. 1) constituted by an actuator (not shown) and the like, and a lifting operation of each squeegee unit 23 with respect to the squeegee base 21 is performed by the control device 8 performing operation control on the squeegee lifting cylinder 22 corresponding to the squeegee unit 23 which is desired to be lifted.

A movement operation of the camera unit 7 is performed by the control device 8 performing operation control on a camera moving mechanism 43 (FIG. 1) constituted by an actuator (not shown) and the like, and control of an imaging operation of the first camera 7a and the second camera 7b included in the camera unit 7 are performed by the control device 8. Image data obtained through the imaging operation of the first camera 7a and the second camera 7b is input to the control device 8 (FIG. 1).

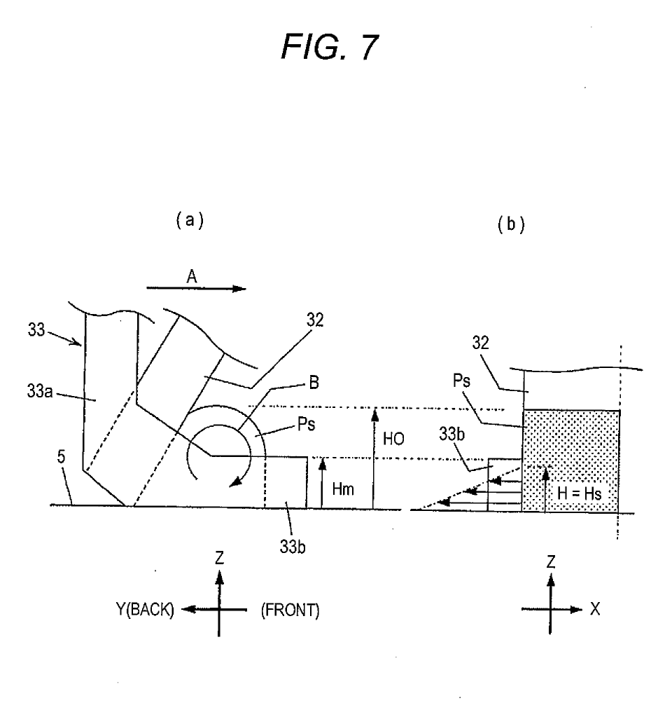

In the screen printer 1 with this configuration, when the squeegee units 23 are moved in the in-horizontal surface direction on the mask 5 which comes into contact with the upper surface of the substrate 2 (the arrow A shown in FIG. 6 and (a) in FIG. 7), the squeegee 32 is slid on the mask 5, and a paste Ps supplied onto the mask 5 is swept by the squeegee 32 and is rolled (the arrow B in FIG. 6 and (a) in FIG. 7,). Thereby, the openings 5a of the mask 5 are filled with the paste Ps, and the paste Ps is transferred to the electrodes 2a on the substrate 2. In addition, when plate separation of separating the substrate 2 from the mask 5 is performed thereafter, this leads to a state in which the paste Ps is printed on the electrodes 2a of the substrate 2.

In this screen printing process, since the pair of leakage prevention members 33 provided at the positions where the squeegee 32 is interposed between both ends thereof are also slid on the mask 5 when the squeegee unit 23 (that is, the squeegee 32) is slid on the mask 5, the paste Ps of which rolling is in progress on the mask 5 and which leaks out of both sides of the squeegee 32 in the width direction (the X axis direction) of the squeegee 32 from the center of the squeegee 32 is dammed up by the pair of leakage prevention members 33. For this reason, the paste Ps of which rolling is in progress on the mask 5 is prevented from leaking (flowing) out of both sides of the squeegee 32 in the width direction from the center of the squeegee 32, and thus the paste Ps efficiently fills the openings 5a of the mask 5.

Here, the paste Ps of which rolling is in progress in the region partitioned by the squeegee 32 and the pair of leakage prevention members 33 may be regarded as having a columnar shape which extends in a longitudinal direction (the X axis direction) of the squeegee 32 as a whole, but frictional resistance from the leakage prevention members 33 acts on both ends (both ends in the X axis direction) thereof, and this impedes the smooth rolling of the entire paste Ps.

However, in the columnar paste Ps of which rolling is in progress, as shown in (a) and (b) in FIG. 7, although a force which tries to flow toward both sides (outside in the width direction) of the squeegee 32 from the center of the squeegee 32 in the width direction is applied to the portion with a specific height (the height H shown in (b) in FIG. 7) from the upper surface of the mask 5 (therefore, a reaction force is received from the leakage prevention members 33), a force which tries to flow from the end parts of the squeegee 32 in the lateral direction is not applied to the portion greater than the height H (refer to a plurality of arrows in the horizontal direction shown in (b) in FIG. 7). Therefore, even if the leakage prevention members 33 are not present on sides of the portion greater than the height H, the paste Ps of which rolling is in progress does not flow out of the sides of the squeegee 32.

In other words, in the screen printer 1 including the leakage prevention members 33 which are provided at the position where the squeegee 32 is interposed between both ends thereof, are slid on the mask 5 along with the squeegee 32, and prevent the paste Ps of which rolling is in progress on the mask 5 from leaking (flowing) out of both sides of the squeegee 32 from the center of the squeegee 32 in the width direction, if a height (specifically, a height of the horizontal portion 33b; (a) in FIG. 7) Hm of the leakage prevention members 33 is equal to or greater than a height H at which a force disappears in which the paste Ps tries to flow out of both sides of the squeegee 32 from the center of the squeegee 32 in the width direction, that is, the height H (hereinafter, referred to as the minimum leakage prevention height Hs; (b) in FIG. 7) at which the sides in the width direction of the paste Ps of which rolling is in progress should be supported in order to prevent the paste Ps from flowing out, the height Hm is not necessarily required to exceed a height (the maximum height) H0 ((a) in FIG. 7) of the paste Ps of which rolling is in progress.

For this reason, in the screen printer 1 according to the present embodiment, the minimum leakage prevention height Hs of the paste Ps is obtained by practically rolling the paste Ps on the mask 5, or the like, and the leakage prevention members 33 with the height Hm which is greater than the obtained minimum leakage prevention height Hs and smaller than the height H0 of the paste Ps of which rolling is in progress are manufactured and are installed in the squeegee holder 31.

In screen printing using the squeegee units 23 including the leakage prevention members 33 manufactured in this way, the paste Ps is rolled in a state in which the height H0 of the paste Ps on the mask 5 is greater than the height Hm of the leakage prevention members 33 from the upper surface of the mask 5, and the paste Ps located at a position greater than the height Hm of the leakage prevention members 33 does not exceed the leakage prevention members 33 and thus does not flow out of both sides of the squeegee 32 from the center of the squeegee 32 in the width direction.

In this screen printing, it is possible to realize smooth rolling of the entire paste Ps by reducing frictional resistance from the leakage prevention members 33 acting on both ends of the paste Ps of which rolling is in progress while the leakage prevention members 33 prevent leakage of the paste Ps out of the squeegee 32.

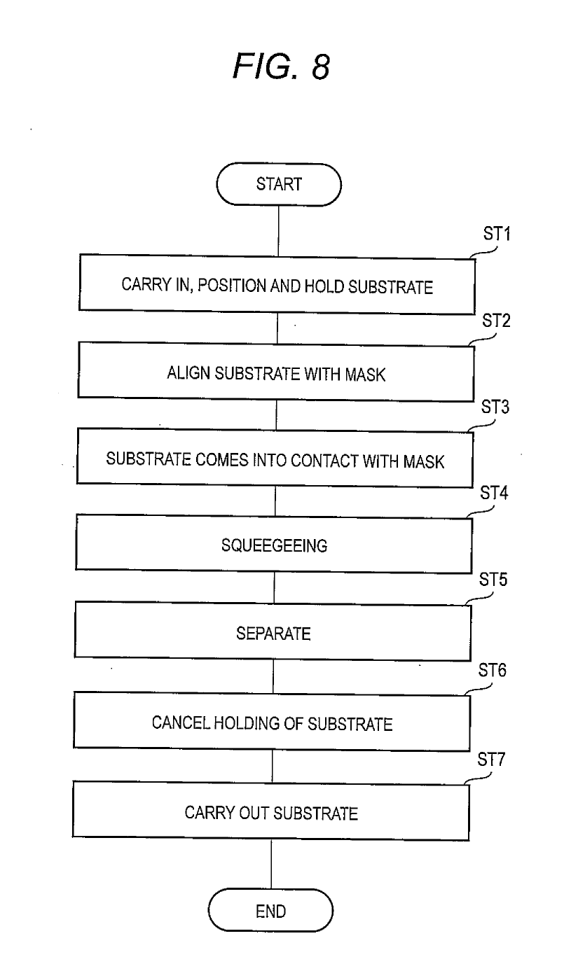

Next, a description will be made of a screen printing method performed by the screen printer 1 according to the present embodiment with reference to FIG. 8. In the screen printing method performed by the screen printer 1, first, the control device 8 performs operation control on the substrate holding and moving unit 4 such that the substrate 2 which is sent by the transport conveyers 16 from the device on the upstream process side of the screen printer 1 is received so as to be carried in and is positioned at a working position. In addition, when the substrate 2 is positioned at the work position, the substrate 2 is clamped by a pair of clamping members 17 with both side parts of the substrate 2 interposed therebetween, and the substrate 2 is held by moving up the lower receiving member 18 so as to come into contact with the lower surface of the substrate 2 (step ST1 shown in FIG. 8).

When the substrate 2 is held, the control device 8 performs operation control on the camera moving mechanism 43 such that the camera unit 7 advances to a region between the substrate 2 held by the substrate holding and moving unit 4 and the mask 5, the first camera 7a images the substrate side marks 2m from the top, and the second camera 7b images the mask side marks 5m from the top. In addition, image recognition is performed on both of the obtained images so as to calculate a positional relationship between the substrate 2 and the mask 5, and the substrate holding and moving unit 4 is moved such that the substrate side marks 2m are located directly under the mask side marks 5m, thereby aligning the substrate 2 with the mask 5 (step ST2 shown in FIG. 8).

After the substrate 2 is aligned with the mask 5, the control device 8 performs operation control on the substrate holding and moving unit 4 so as to move up the base portion 14, and thereby the upper surface of the substrate 2 comes into contact with the lower surface of the mask 5. This leads to a state in which the electrodes 2a on the substrate 2 coincide with the openings 5a of the mask 5 (step ST3 shown in FIG. 8).

As above, step ST3 is a process in which the mask 5 comes into contact with the upper surface of the substrate 2 in the screen printing method according to the present embodiment.

When the upper surface of the substrate 2 comes into contact with the lower surface of the mask 5, the control device 8 enters a state of waiting for an operator to supply the paste Ps onto the mask 5, and when the operator supplies the paste Ps onto the mask 5 by using a separately prepared paste supply device and performs a predetermined operation, the control device 8 performs squeegeeing work on the paste Ps by using the squeegeeing mechanism 6 (step ST4 shown in FIG. 8).

This squeegeeing work is performed by moving the squeegee base 21 in the horizontal direction (the Y axis direction) after the lower end part of the squeegee 32 included in one squeegee unit 23 which is moved down with respect to the squeegee base 21 comes into contact with the upper surface of the mask 5 and by sliding the squeegee 32 on the mask 5 (refer to FIG. 1). Thereby, the paste Ps is rolled on the mask 5, and the paste Ps fills the openings 5a of the mask 5.

Here, when the squeegee base 21 is moved from the front side of the screen printer 1 to the back side thereof (in FIGS. 1 and 2, from the right side to the left side of the figures), the squeegeeing is performed in a state in which the squeegee 32 located on the front side comes into contact with the upper surface of the mask 5, and when the squeegee base 21 is moved from the back side of the screen printer 1 to the front side thereof (in FIGS. 1 and 2, from the left side to the right side of the figures), the squeegeeing is performed in a state in which the squeegee 32 located on the back side comes into contact with the upper surface of the mask 5.

As above, in the screen printer 1 according to the present embodiment, the squeegee 32 is slid on the mask 5 which comes into contact with the upper surface of the substrate 2 such that the paste Ps supplied onto the mask 5 is rolled on the mask 5, and thereby the paste Ps is transferred to the substrate 2.

In addition, step ST4 is a process in which the squeegee 32 is slid on the mask 5 which comes into contact with the upper surface of the substrate 2, the paste Ps supplied onto the mask 5 is rolled on the mask 5 by the squeegee 32, and thereby the paste Ps is transferred to the substrate 2 in the screen printing method according to the present embodiment.

When the squeegeeing work is completed, the control device 8 moves down the base portion 14 so as to separate the substrate 2 from the mask 5. Thereby, plate separation is performed, and thereby a state arrives in which the paste Ps is printed on the electrodes 2a on the substrate 2 (step ST5 shown in FIG. 8).

When the plate separation is completed, the control device 8 cancels holding of the substrate 2 by moving down the lower receiving member 18 after canceling clamping of the substrate 2 by the clamping members 17 (step ST6 shown in FIG. 8). In addition, the transport conveyers 16 are operated such that the substrate is carried out to a device (for example, a part installation machine which installs parts in the substrate 2) on the downstream process side of the screen printer 1 (step ST7 shown in FIG. 8). Thereby, the screen printing process per sheet of the substrate 2 also finishes.

As described above, in the screen printer 1 and the screen printing method according to the present embodiment, the paste Ps is rolled in a state in which the height of the paste Ps on the mask 5 is greater than the height Hm of the leakage prevention members 33 from the upper surface of the mask 5, and the paste Ps located at a position greater than the height Hm of the leakage prevention members 33 does not exceed the leakage prevention members 33 and thus does not flow out of both sides of the squeegee 32 from the center of the squeegee 32 in the width direction. Therefore, it is possible to realize smooth rolling of the entire paste Ps by reducing frictional resistance from the leakage prevention members 33 acting on both ends of the paste Ps of which rolling is in progress while the leakage prevention members 33 prevent leakage of the paste Ps out of the squeegee 32. Thereby, it is possible to reduce occurrence of poor printing.

In addition, the above-described shape of the leakage prevention members 33 is only an example, and a shape thereof is not limited as long as the leakage prevention members are slid on the mask 5 along with the squeegee 32 such that the paste Ps of which rolling is in progress on the mask 5 is prevented from leaking out of both sides of the squeegee 32 from the center of the squeegee 32 in a width direction.

In addition, although, in the present embodiment, a pair of leakage prevention members 33 are provided at positions where the squeegee 32 is interposed between both ends thereof in a longitudinal direction (X axis direction), the pair of leakage prevention members 33 may be provided at positions located further toward the central side than the end parts of the squeegee 32.

This application is based on Japanese Patent Application No. 2011-034089 filed Feb. 21, 2011, contents of which are incorporated herein by reference.

### INDUSTRIAL APPLICABILITY

There are provided a screen printer and a screen printing method capable of reducing occurrence of poor printing by realizing smooth rolling of a paste.

### REFERENCE SIGNS LIST

1 SCREEN PRINTER

2 SUBSTRATE

5 MASK

31 SQUEEGEE HOLDER

32 SQUEEGEE

33 LEAKAGE PREVENTION MEMBER

Ps PASTE

Hm HEIGHT OF LEAKAGE PREVENTION MEMBER

H0 HEIGHT OF PASTE

1. A screen printer comprising:
a mask that comes into contact with an upper surface of a substrate;
a squeegee that is slid on the mask which comes into contact with the upper surface of the substrate and rolls a paste supplied onto the mask on the mask so as to transfer the paste to the substrate; and
a leakage prevention member that is provided in a squeegee holder holding the squeegee and is slid on the mask along with the squeegee so as to prevent the paste of which rolling is in progress on the mask from leaking out of both sides of the squeegee from a center of the squeegee in a width direction,
wherein the paste is rolled in a state in which a height of the paste on the mask is greater than a height of the leakage prevention member from the upper surface of the mask, and the paste located at a position greater than the height of the leakage prevention member does not exceed the leakage prevention member and thus does not flow out of both sides of the squeegee from the center of the squeegee in the width direction.

2. A screen printing method comprising:
causing a mask to come into contact with an upper surface of a substrate;
causing a squeegee to be slid on the mask which comes into contact with the upper surface of the substrate and to roll a paste supplied onto the mask on the mask so as to transfer the paste to the substrate; and
causing a leakage prevention member provided in a squeegee holder holding the squeegee to be slid on the mask along with the squeegee so as to prevent the paste of which rolling is in progress on the mask from leaking out of both sides of the squeegee from a center of the squeegee in a width direction;
wherein the paste is rolled in a state in which a height of the paste on the mask is greater than a height of the leakage prevention member from the upper surface of the mask, and the paste located at a position greater than the height of the leakage prevention member does not exceed the leakage prevention member and thus does not flow out of both sides of the squeegee from the center of the squeegee in the width direction.
